(19) United States
(12) Patent Application Publication
(10) Pub. No.: US 2011/0295565 A1
(43) Pub. Date: Dec. 1, 2011

(54) METHODS AND SYSTEMS OF INTEGRATED SIMULATIONS FOR PATIENT-SPECIFIC BODY EMBEDDED WITH MEDICAL IMPLANTS

(75) Inventor: Metin Ozen, Sunnyvale, CA (US)

(73) Assignee: Ozen Engineering Inc., Sunnyvale, CA (US)

(21) Appl. No.: 13/115,042

(22) Filed: May 24, 2011

Related U.S. Application Data
(60) Provisional application No. 61/347,847, filed on May 25, 2010.

(51) Int. Cl. G06F 17/50; G06G 7/60

(52) U.S. Cl. 703/1; 703/11

(57) ABSTRACT

Methods and computer readable media for designing an implant to support a bone of a person. Based on the daily activities of the person, one or more musculoskeletal loads applied to the bone are determined. Also, a set of characteristics of the implant, such as dimension, material, geometry, and shape of the implant, is selected. Then, a numerical simulation of the implant and the bone is performed to determine a physical status of the implant under the musculoskeletal loads. Subsequently, it is determined if the physical status meets one or more of preset failure conditions. If the determination is negative, the implant is taken as an optimized implant. Otherwise, at least one of the characteristics of the implant is modified and numerical simulation of the implant and the bone is repeated until an optimized implant is obtained.

### CROSS-REFERENCE TO RELATED APPLICATIONS

This application claims the benefit of the filing date of Provisional Patent Application Ser. No. 61/347,847 filed on May 25, 2010, entitled “Method of Integrated Simulations for Patient-Specific Body Embedded with Medical Implants,” which is hereby incorporated by reference by its entirety.

### TECHNICAL FIELD

The present invention relates to designing medical implants, and more particularly, systems and methods for designing custom-fitted implants based on personal activities of the patient.

### BACKGROUND OF THE INVENTION

With the advent of surgical technology and material science, various types of devices have been implanted in the human body to allow the patient to be restored to normal mobility and activity and/or to relieve pain. For example, a patient suffering from arthritis may enjoy excellent results from total replacement of the infected joint with a man-made mechanical joint. In another example, a metal plate may be fixed to a fractured femur bone to secure the broken pieces to each other, and to provide mechanical support to the femur bone so that the patient can perform normal daily activities during and after the healing period.

Medical imaging technologies, such as computed tomography (CT) and magnetic resonance imaging (MRI), combined with advances in computer-based image processing and modeling capabilities, have been used to locate and diagnose internal injuries such as fractured femur bones. Upon determination of the extent and scope of the injury, the physician may select a plate to be fixed to the fractured femur bone based on his own experience or the specifications provided by the plate manufacturer. To obtain better clinical results, a smaller dimension of the plate would be preferred. However, if the plate is too thin to withstand the physiological loads applied to the damaged femur bone, the plate would break into pieces, further aggravating the injury to the bones, as well as harming muscles, tissues and other internal organs around the femur bone.

The physiological loads may vary depending on various factors, such as the patient's profession, physical activities, body weight, age, gender, and so on. It would be very difficult, if not impossible, for a physician to select the optimum dimension of the implants while taking into these personal factors into account. Also, the manufacturer's specification may not be set to withstand the physiological loads applied to the femur bone of each individual patient. Thus, there is a strong need for systems and methods which can optimize the dimension of the implants in a custom-tailored manner.

### SUMMARY OF THE INVENTION

In one embodiment of the present invention, a method and computer readable media are provided for designing an implant to support a bone of a person. The method includes: (a) determining one or more musculoskeletal loads applied to the bone based on an activity of the person; (b) selecting a set of characteristics of the implant; (c) performing a numerical simulation of the implant and the bone to determine a physical status of the implant under the musculoskeletal loads; and (d) determining if the physical status meets one or more of preset failure conditions. If the determination in step (d) is negative, the implant is taken as an optimized implant. However, if the determination in step (d) is positive, at least one of the characteristics of the implant is modified and the steps (c) and (d) are repeated.

In another embodiment, a computer having a processor for running computer-readable program code in memory is provided. The computer includes: a first computer program for preparing a physiological loading condition of the person based on an activity of a person; a second computer program for determining one or more musculoskeletal loads applied to a bone under the physiological loading condition; and a third computer program for simulating an implant and the bone to determine a physical status of the implant under the musculoskeletal loads.

These and other features, aspects and advantages of the present invention will become better understood with reference to the following drawings, description and claims.

### BRIEF DESCRIPTION OF THE DRAWINGS

FIG. 1 shows exemplary images generated by Computerized-Axial-Tomography (CAT) scan technique to read the geometry of a patient's body in accordance with one embodiment of the present invention.

FIG. 2A shows a musculoskeletal image of the patient on a bicycle, where the musculoskeletal image is generated using the CAT scan images in FIG. 1.

FIG. 2B shows a musculoskeletal image of the patient doing the bench press exercise, where the musculoskeletal image is generated using the CAT scan images in FIG. 1.

FIG. 2C shows a dimensional image of a fractured femur bone in the musculoskeletal image of FIG. 2A.

FIG. 3 illustrates a free body diagram of musculoskeletal loads on the femur bone in FIG. 2C, where the musculoskeletal loads are calculated by numerical simulation of the cycling motion of the musculoskeletal image in FIG. 2A.

FIG. 4 shows the musculoskeletal loads of FIG. 3 superimposed on the three dimensional image of the femur bone in FIG. 2C.

FIG. 5A shows an exemplary fixation plate implant system of the type that might be used to support a fractured femur bone in FIG. 2C.

FIG. 5B shows a finite element model of the fractured femur bone of FIG. 2C and the fixation plate implant system of FIG. 5A.

FIG. 5C shows an enlarged view of a portion of the femur bone in FIG. 5B.

FIG. 6A shows an exemplary result of numerical simulation for mechanical stress developed in the fixation plate in FIG. 5C under the musculoskeletal loads on the femur bone in FIG. 4, where the thickness of the implant plate is 3.25 mm.

FIG. 6B shows an exemplary result of numerical simulation for mechanical stress developed in the fixation plate in FIG. 5C under the musculoskeletal loads on the femur bone in FIG. 4, where the thickness of the implant plate is 4.00 mm.

FIG. 6C shows an exemplary result of numerical simulation for mechanical stress developed in the fixation plate in FIG. 5C under the musculoskeletal loads on the femur bone in FIG. 4, where the thickness of the implant plate is 4.75 mm.

FIG. 7 shows a table of various thicknesses of the fixation plate in FIG. 5C and the number of cycles at the onset of fatigue failure for each thickness.

FIG. 8 shows a flow chart illustrating exemplary steps that may be carried out to determine the optimum thickness of the femur implant in FIG. 5B in accordance with another embodiment of the present invention.

FIG. 9 is a schematic diagram of a typical computer system that may be employed in accordance with the present invention.

### DETAILED DESCRIPTION

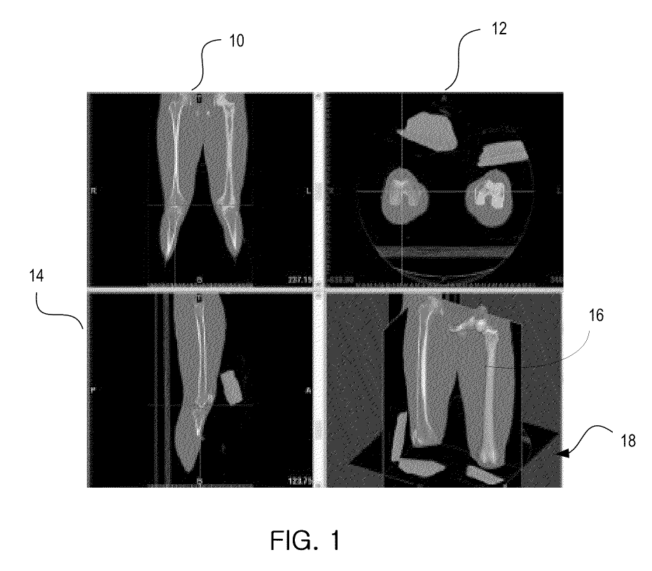

Referring now to FIG. 1, there are shown exemplary images 10, 12, 14, and 16 generated by CAT scan technique to read the geometry of a patient's body in accordance with one embodiment of the present invention. As depicted, images 10, 12, 14, and 16 represent cross-sectional views of the patient body taken along various directions. A suitable computer program, such as the Mimics™ computer program developed by Materialise Group at Leuven, Belgium, may be used to generate three dimensional image from the two dimensional cross-sectional views. In addition, the two dimensional views of a target object, such as a fractured bone or organ having cancer cells, may be integrated into an isolated three dimensional view thereof.

For simplicity, the CAT scan image will be limited to reading the geometry of muscles and bones in the following discussion. However, it should be apparent to those of ordinary skill in the art that the CAT scan technique can be used to generate two and three dimensional views of other internal organs of the patient. It should be also apparent to those of ordinary skill in the art that other suitable types of scanning technique may be used to get the images of the patient.

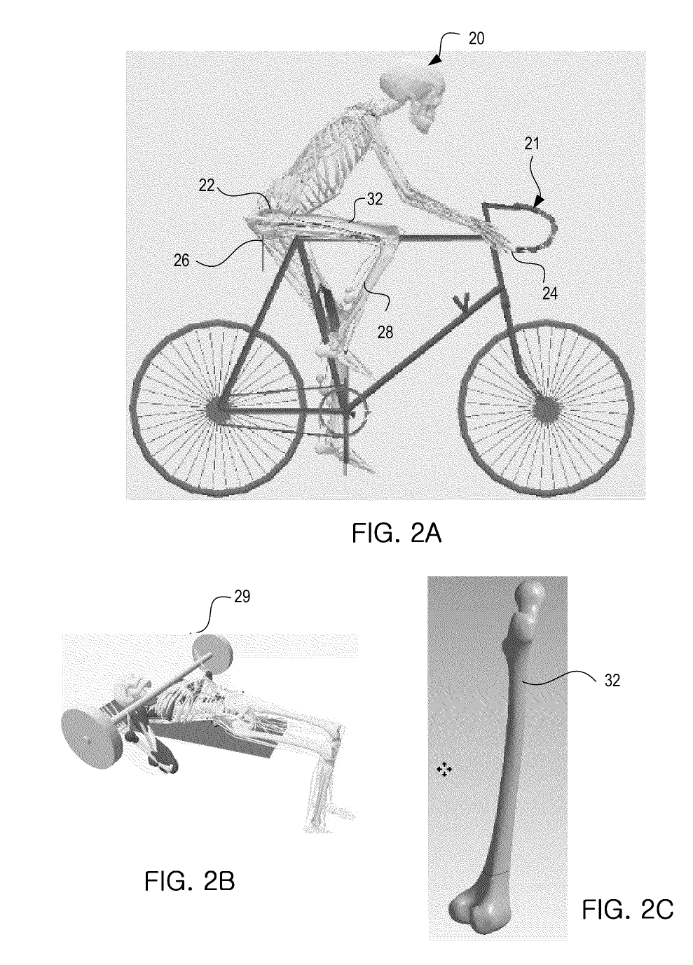

FIG. 2A shows a musculoskeletal image (or, equivalently, musculoskeletal model) 20 of the patient on a bicycle 21, where the musculoskeletal image is generated using the CAT scan images in FIG. 1. In one embodiment, the images of the bones and muscles of the patient are extracted from the CAT scan images 10-18 in FIG. 1 and then integrated into the musculoskeletal image 20. In another embodiment, an ordinary person's body may be scanned in advance and his/her musculoskeletal image can be stored in a database as a generic musculoskeletal image. Then, depending on the physical characteristics of the patient, the generic musculoskeletal image may be adjusted to generate the image 20 specific to the patient. For example, in the case where the patient has a fractured femur bone, the length of the patient's thigh is measured, and the length of the femur bone of the generic musculoskeletal image and/or the size of the muscles attached to the femur bone of the generic musculoskeletal image may be adjusted. In another example, the bone density of the generic musculoskeletal image may be also changed according to the age of the patient.

Physiological loading data are recorded in advance from an experienced cyclist on a raised bicycle fixture in a laboratory. Reflective markers are placed on the outside of the thigh, knee, and ankle and used as reference locations for tracking the motion. The cyclist is asked to cycle at a comfortable speed and the average observed cadence of 62 rpm may be used as input in the musculoskeletal model.

A suitable computer simulation software, such as the Anybody Modeling System™, developed by AnyBody Technology A/S at Aalborg, Denmark, may be used to determine the musculoskeletal loads on the musculoskeletal model 20 under the physiological loading conditions of a pedaling (cycling) exertion. In the musculoskeletal simulation model using the Anybody Modeling System™, five points of supports between the whole musculoskeletal model 20 and the bicycle 22 are defined, where the five points of supports hands 24, pelvis 26 and feet 28.

FIG. 2B shows a musculoskeletal image 29 of the patient doing the bench press exercise, where the musculoskeletal image is generated using the approach described in conjunction with FIG. 2A. As in FIG. 2A, a simulation computer software, such as the AnyBody Modeling System™, may be used to determine physiological loading conditions of the bench press exercise.

In FIGS. 2A and 2B, cycling and bench press exercise are assumed to be the daily activities of the patient. However, it should be apparent to those of ordinary skill that each patient may have his/her own specific daily activities, such as jogging, hiking, swimming, walking, etc., and the similar analysis can be performed to determine the musculoskeletal loads on the model 20. Thus, the musculoskeletal loads calculated by the embodiment of the present invention are custom-tailored and patient specific. It is noted the physiological loading conditions for the various activities are also obtained from ordinary persons in advance and stored in the database.

FIG. 2C shows a three dimensional image of a fractured femur bone 32 in the musculoskeletal image 20 of FIG. 2A. As discussed above, the CAT scan technique is able to provide an isolated three dimensional view of the target object, such as the fractured femur bone 32.

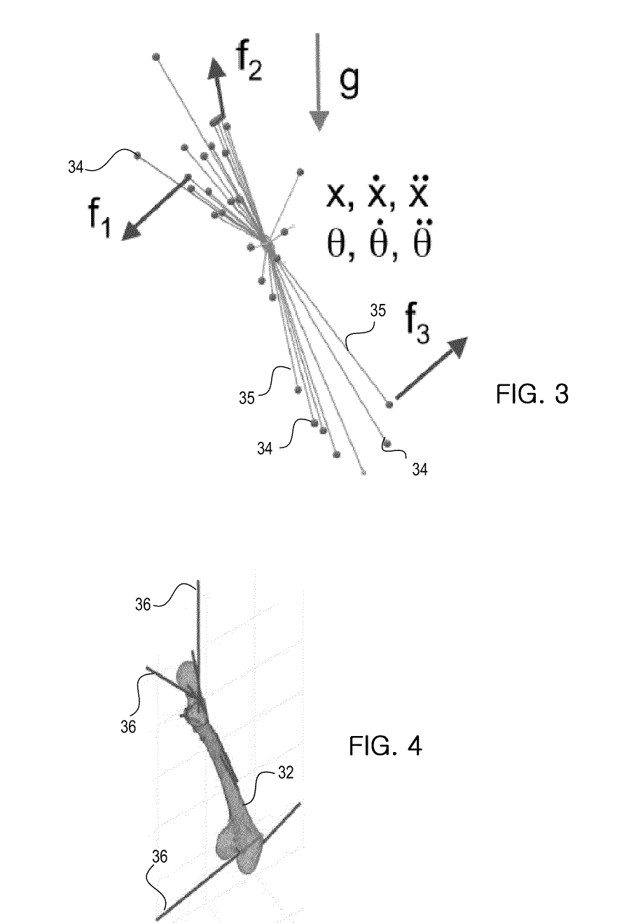

FIG. 3 illustrates musculoskeletal loads f1, f2, and f3 on the femur bone (shown in FIG. 2C) with locations and directions of loads, where the musculoskeletal loads are outputs from the AnyBody Modeling System™ that takes the musculoskeletal image 20 and the physiological loading conditions (such as cycling or bench pressing) as input data. Since the physiological loadings change as functions of time, the user of the AnyBody Modeling System™ may select a point in time where the loadings are at their maximum so that the maximum musculoskeletal loads are obtained.

As depicted in FIG. 3, the lines 35 represent muscles attached to the femur bone at the attachment points 34. In addition to the gravitational force g, the musculoskeletal loads include dynamic forces associated with linear (x) and angular (A) acceleration. These forces on the femur bone are used as inputs to a finite element model of a fracture fixation implant, as discussed below.

FIG. 4 shows the musculoskeletal loads of FIG. 3 superimposed on the three dimensional image of the femur bone 32. As depicted, each line segment 36 represents the musculoskeletal force applied to the femur bone 32, where the orientation and length of the line segment respectively represent the direction and magnitude of the musculoskeletal force represented thereby.

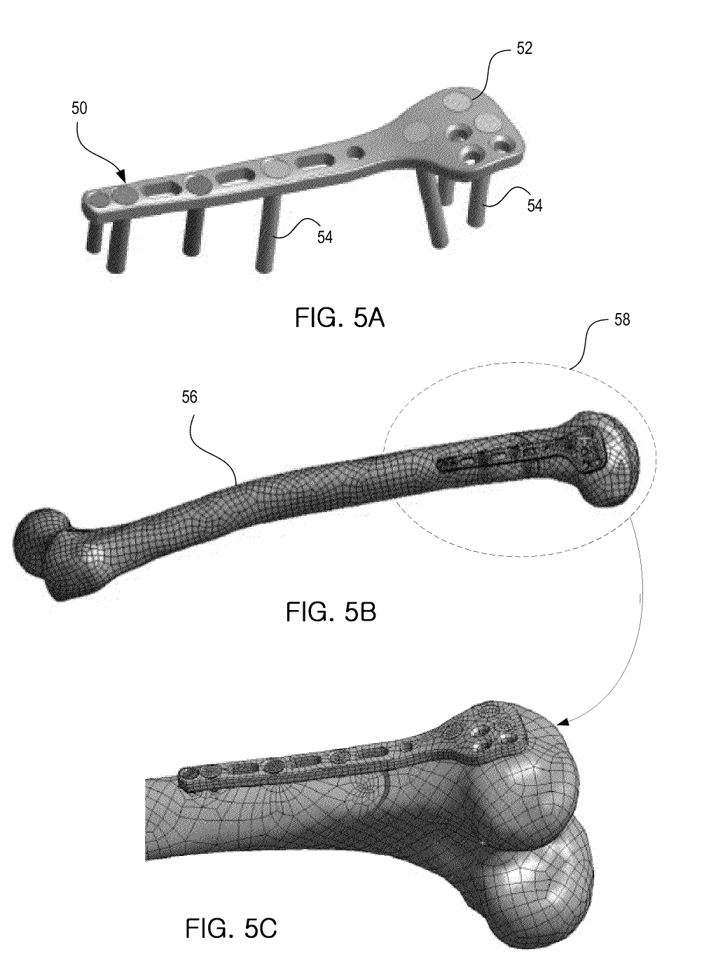

FIG. 5A shows an exemplary fixation plate implant system 50 for a fractured femur bone with screws 54, where the fixation plate implant system 50 includes a distal lateral femoral locking plate (or, shortly fixture plate) 52 with holes to accommodate the screws 54. FIG. 5B shows a finite element model of the fractured femur bone 56 and the fixation plate implant system 50, where the mesh represents the finite element grids. As depicted, the fixation plate implant system 50 is attached to the fractured femur bone 56 by the screws 54 and provides mechanical support to the fractured femur bone 56. An enlarged view of a joint region 58 of the fractured femur bone 56 and the fixation plate implant system 50 is shown in FIG. 5C.

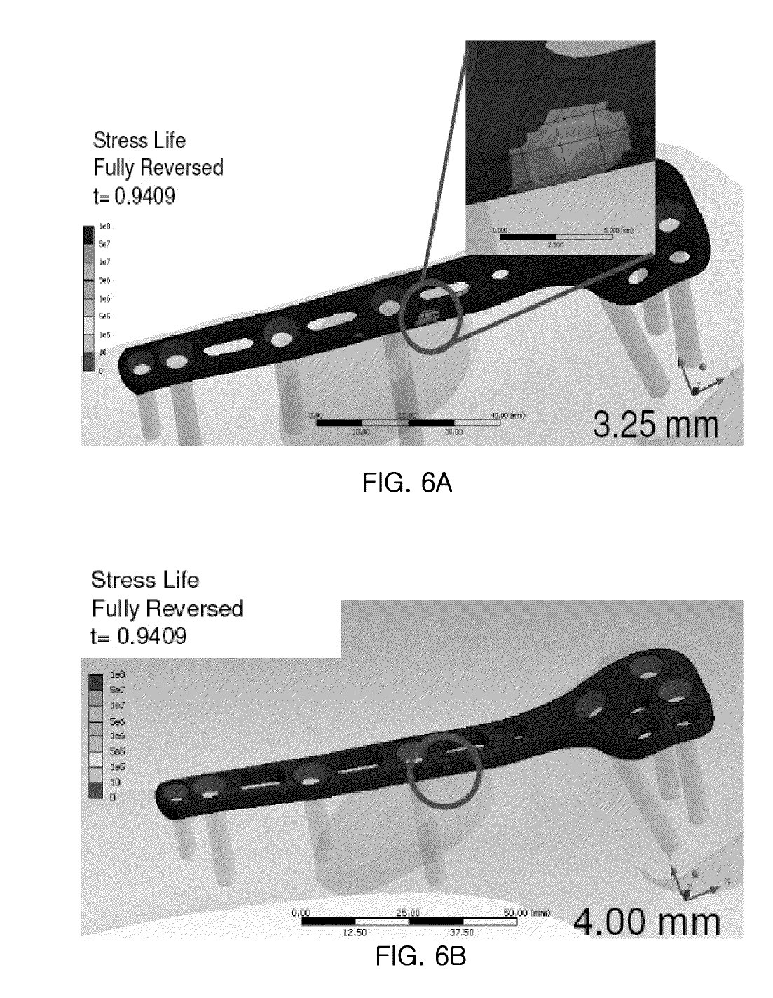

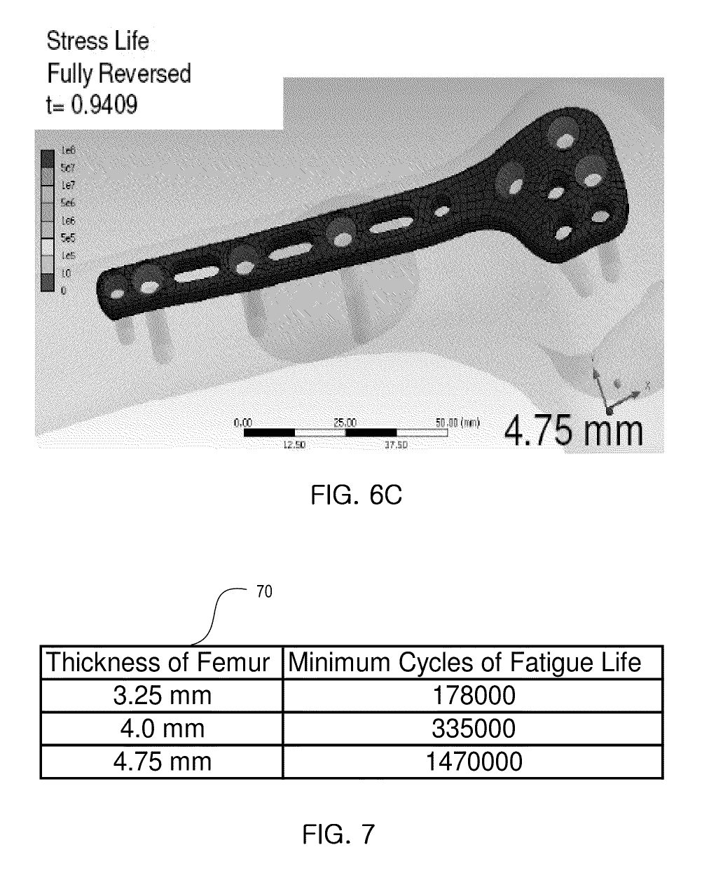

FIG. 6A-6C show exemplary results of the finite element analysis for mechanical stress developed in the implant plate in FIG. 5C under the musculoskeletal loads on the femur bone 32 in FIG. 4, where the thicknesses of the fixation plate 52 are 3.25 mm, 4.00 mm, and 4.75 mm, respectively. As depicted, the mechanical stress distribution may be visualized on the gray scale or color encoding. Also, the finite element analysis may be able to simulate the deformation of the separate bone segment of the fractured femur bone 56 (for brevity, the deformation result is not shown in FIGS. 6A-6C). The finite element model of the femur bone 32 and the fixation plate 52 consists of 45,439 elements with 166,994 nodes, and the material for the fixation plate implant system 50 was titanium alloy (Ti-6Al-4V).

FIG. 7 shows a table 70 of various thicknesses of the fixation plate in FIG. 5C and the number of cycles at the onset of fatigue failure for each thickness. The first column of the table 70 shows various thicknesses of the fixation plate 52, and the second column shows the number of cycles at the onset of fatigue failure under the patient-specific daily living conditions, such as cycling, for instance.

The stress distributions in FIGS. 6A-6C, the deformation of bone segments, and the table 70 may be used to check whether the three implant designs pass the following failure conditions: (1) deformation resulting in contact between separate bone segments, (2) stresses in the plate beyond the material yield strength, and (3) minimum fatigue life below 5 million cycles. The failure conditions may be analyzed over the full cycling cadence and the results from a characteristic time step (97% of the cadence with a right knee flexion of 112 degrees) may be presented. With regard to the first failure condition, none of the plate configurations, subject to the pedaling loading, violates the deformation failure criteria. With regard to the second failure condition, none of the Von-Mises stresses in any of the tested implant designs exceeds the yield point of the material (930 Mpa). However, for the third failure condition, only the 4.75 mm thick implant achieves the desired fatigue life of 5 million cycles, with a predicted fatigue life of 14.7 million cycles. The 4.00 mm and 3.25 mm thick plate designs fail at 335,000 and 178,000 cycles, respectively.

It is noted that other failure conditions may be used to determine whether each design of the fixation plate implant system passes the failure conditions. Under preset failure conditions, the implant designer may vary the dimension, shape, and material of the fixation plate while the patient-specific physiological loading conditions of the patient are taking into account to obtain the optimum fixation plate for the femur bone of the patient. Also, the locations of the screws 54 may be changed to optimize the stress distribution in the fixation plate 52.

In conventional approaches, the process of using activities of daily living to evaluate the performance of implanting devices under physiological loading conditions has been developed. However, conventional methods that utilize estimated physiological loading conditions are traditionally used as pass/fail tests to identify whether a particular design performs to a set of minimum specifications for long-term use. Such conventional tests are also traditionally limited to a small number of physiologically representative loading conditions (i.e., walking, stair climbing, sit-to-stand).

Since a limited number of activities were used as physiological loading conditions in pre-clinic evaluations of the conventional approaches, there exists a scarcity of data related to everyday activities. Due to such limited contributing factors, everyday activities are underutilized in the conventional design phase for evaluating new implant geometries, materials, and configurations. This conventional approach is supported with the perception that only a failure to pass minimum criteria associated with a physiological loading condition traditionally results in a design change, and not fully incorporated as a component to a robust design process that seeks to maximize the life cycle of an implant subject to the same loading profile.

In contrast, the embodiment of the present invention described in conjunction with FIGS. 1-7 includes a methodology for incorporating musculoskeletal simulation as a tool for providing physiologically representative boundary conditions in the design of new implant. The thickness of the distal femoral fracture fixation plate 52 (shown in FIG. 5A) may be varied and evaluated under the physiological loading condition of a pedaling (cycling) exertion. It should be apparent to those of ordinary skill that the same musculoskeletal model can be applied under various other physiological loading conditions, such as doing bench press exercise (FIG. 2B), that are specific to the patient. Since the physiological loading conditions are determined by the personal activities that are specific to the patient, the entire design process of the fixation plate implant system 50 is highly custom-tailored and fitted to the specific needs of each individual patient.

It is also noted that the primary impact of the method according to the embodiment of the present invention lies in the capability of extracting boundary loading conditions that are specific to the patient, and applying those to finite element model analyses through computer simulation, which may be subsequently automated. Such a unified methodology provides a new approach to combine multiple tests with activities of daily living in the design process to optimize a particular implant subject to selected criteria.

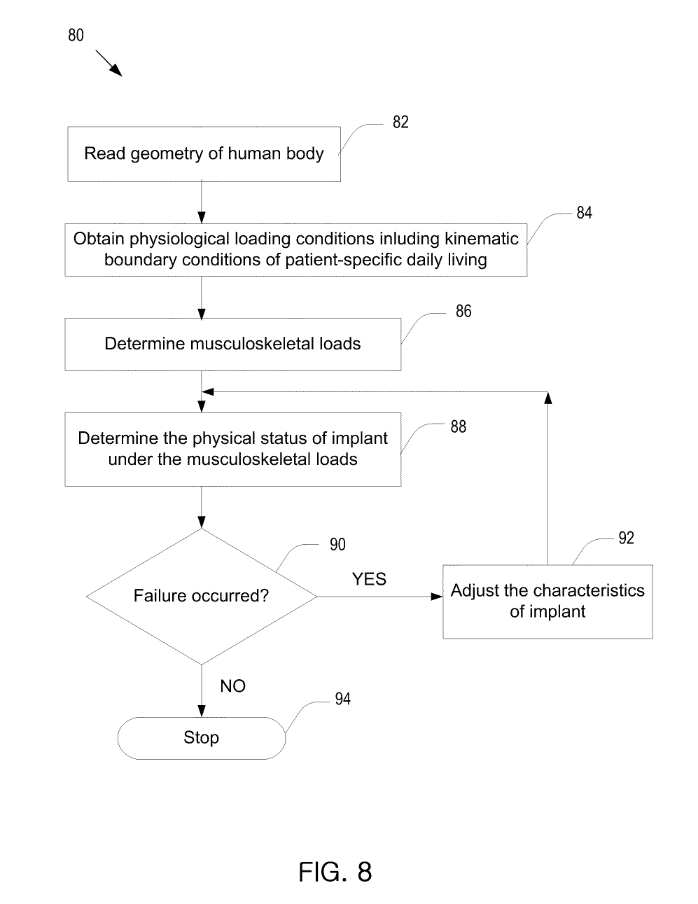

FIG. 8 shows a flow chart 80 illustrating exemplary steps that may be carried out to optimize the femur implant system 50 in FIG. 5B in accordance with another embodiment of the present invention. The process begins in a step 82. In the step 80, the geometry of a patient body may be read by using a suitable scanning technique, such as CAT scan technique. The scanned image is used to generate a three dimensional image of the target object, such as fractured bone, inside the patient body. Also, the scanned image is used to generate a musculoskeletal image of the patient, as discussed in conjunction with FIG. 1.

Next, in a step 84, physiological loading conditions, such as cycling, exercising bench press, jogging, walking, swimming, etc., that are specific to the patient may be obtained. These conditions may also include kinematic boundary conditions of the patient-specific daily living, where the kinetic boundary conditions are caused by linear and/or rotational acceleration of the patient body. These conditions may be also obtained from an ordinary person in a laboratory condition in advance and stored in a database. Then, in a step 86, a computer simulation program, such as the Anybody Modeling System™, may be used to determine the musculoskeletal loads under the obtained physiological loading conditions.

Subsequently, a suitable computer simulation technique, such as a finite element analysis program like the Ansys™ computer simulation program developed by ANSYS at Canonsburg, Pa., may be applied to determine the physical status of the fractured femur bone 56 and the fixation plate implant system 50 under the musculoskeletal loads in the step 88. In one embodiment, the musculoskeletal loads are used as input data of the finite element analysis. The physical status may include, for instance, deformation of the separate bone fractures 56, stress distribution in the fixation plate implant system 50 and the bone 56, and the onset of fatigue failure of the fixation plate implant system 50.

It is noted that a suitable computer software, such as the Any2Ans™ computer program developed by the present inventor, may be used to connect the results from the Anybody Modeling System™ with a finite element analysis program, such as the Ansys™ computer simulation program.

Then, in a step 90, a determination as to whether a failure of the fixation plate implant system 50 has occurred is made. The determination of failure may be made by checking if any one or more of the failure conditions has occurred, where the failure conditions may include: (1) deformation resulting in contact between separate bone segments of the fractured femur bone, (2) stresses in the fixation plate implant system and the femur bone are greater than the allowable limits, and (3) the number of cycles at the onset of fatigue failure is below an allowable standard, such as 5 million cycles. Upon affirmative answer to the decision diamond 90, at least one of the characteristics, such as dimension, material, geometry, and shape of the fixation plate implant system 50, and the locations of the screws 54, may be adjusted in a step 92. For instance, the thickness of the plate 52 of the fixation plate implant system 50 may be increased. Then, the process may proceed back to the step 88. If the answer to the decision diamond 90 is negative, the fixation plate implant system is considered to be optimized, and the process stops in a state 94.

It is noted that FIGS. 1-8 are directed to designing an implant to support a fractured femur bone. However, it should be apparent to those of ordinary skill that the embodiments described in conjunction with FIGS. 1-8 can be applied to a bone that is weakened due to other sources of damages, such as aging and osteoporosis. As such, the “injury” refers to a weakening process occurred in a bone, either rapidly or slowly.

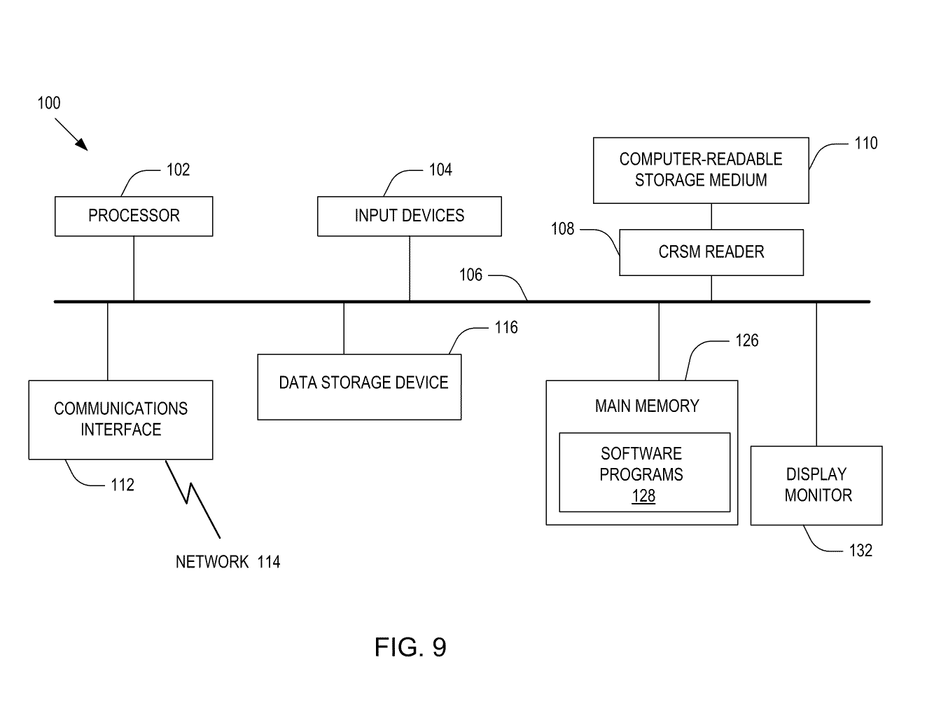

FIG. 9 is a schematic diagram of a typical computer system shown at 100 that may be employed in accordance with the present invention. Depending on its configuration, the computer system may be employed as a desktop computer, a server computer, or an appliance, for example and may have less or more components to meet the needs of a particular application. As illustrated, the computer system may include a processor 102, such as those from the Intel Corporation or Advanced Micro Devices, for example. The computer system may have one or more buses 106 coupling its various components. The computer system may also include one or more input devices 104 (e.g., keyboard, mouse), a computer-readable storage medium (CRSM) 110, a CRSM reader 108 (e.g., floppy drive, CD-ROM or DVD drive), a display monitor 132 (e.g., cathode ray tube, flat panel display), a communication interface 112 (e.g., network adapter, modem) for coupling to a network 114, one or more data storage devices 116 (e.g., hard disk drive, optical drive, FLASH memory), and a main memory 126 (e.g., RAM). Software programs 128, such as the Anybody Modeling System™Ansys™ computer simulation program, Any2Ans™, and Mimics™, may be stored in the computer-readable storage medium 110 and read into the data storage devices 116 or main memory 126 as illustrated in FIG. 9. Also, the musculoskeletal images and physiological data obtained from an ordinary person under laboratory conditions may be also stored in the data storage device 116. As one of ordinary skill in the programming art can implement without undue experimentation the software programs 128, a detailed description as to the implementation of the software programs 128 is not given in the present document. It is also noted that those of ordinary skill can implement various software programs without undue experimentation that can carry out one or more steps in the processes 80. The communication interface 112 may be used to get the information of the patient who is remotely located via the network 114, such as the Internet. For instance, a remotely located patient may provide his personal activity information and/or his musculoskeletal image via the Internet, i.e., the patient may send such information from his computer to the computer 100 via the Internet.

The use of personal activities of daily living, modeled with musculoskeletal simulations, as input criteria for implant design allows the implant designer to optimize the dimension of the implants in a custom-tailored manner. The process described with reference to FIGS. 1-8 is an approach based on the understanding of how the forces from everyday, recreational, and/or exercise activities are balanced by an implant. For the purpose of illustration, only one fixation plate implant system 50 is described in the present document. However, it should be apparent to those of ordinary skill that the methodology is equally translatable to joint replacement design, such as total hip replacement, Total-Knee-Replacement, etc.). It should be also apparent to those of ordinary skill that the same technique may be applied to animals.

With the capacity to depict and assess physiological loading conditions during pre-clinical developments through in-silico testing, the design of implantable devices can be optimized for select failure/performance criteria. The methodologies described in conjunction with FIGS. 1-8 may be used to determine the effects of critical design factors, including the effect of screw 54 locations and material selection on the structural integrity of the plate 52 and the bone 56, the fatigue life cycle during realistic operating conditions, and the locations of high stress concentrations. The present methodology provides more robust medical implants (improving longevity), better tested devices prior to clinical trials (reducing potential patient risk), and designs optimized for particular populations and/or exercise activities.

It should be understood, of course, that the foregoing relates to exemplary embodiments of the invention and that modifications may be made without departing from the spirit and scope of the invention as set forth in the following claims.

What is claimed is:

1. A method for designing an implant to support a bone of a person, comprising:
(a) determining one or more musculoskeletal loads applied to the bone based on an activity of the person;
(b) selecting a set of characteristics of the implant;
(c) performing a numerical simulation of the implant and the bone to determine a physical status of the implant under the musculoskeletal loads;
(d) determining if the physical status meets one or more of preset failure conditions;
(e) if the determination in step (d) is negative, taking the implant as an optimized implant; and
(f) if the determination in step (d) is positive, further comprising the steps of
(i) modifying at least one of the characteristics of the implant; and
(ii) repeating the steps (c) to (f).

2. A method as recited in claim 1, wherein the step (a) includes:
preparing a musculoskeletal model of the person;
preparing a physiological loading condition of the person based on the activity of the person; and
performing a numerical simulation on the musculoskeletal model under the physiological loading condition to determine the one or more musculoskeletal loads.

3. A method as recited in claim 2, wherein the step of preparing the musculoskeletal model includes:
performing a computerized-axial-tomography (CAT) scan on the person's body; and
generating the musculoskeletal model using CAT scan images.

4. A method as recited in claim 2, wherein the step of preparing the musculoskeletal model includes:
preparing a generic musculoskeletal model; and
adjusting a portion of the generic musculoskeletal model based on the patient body geometry.

5. A method as recited in claim 1, wherein the step (c) includes:
applying a finite element model on the implant and the bone.

6. A method as recited in claim 1, wherein the physiological status includes deformation of the bone, a stress distribution in the implant and the bone, and an onset of fatigue failure of the implant.

7. A method as recited in claim 1, wherein the preset failure conditions include a deformation resulting in contact between separate bone segments of the bone, stresses in the implant and the bone are greater than allowable limits, and a number of cycles at an onset of fatigue failure is below an allowable standard.

8. A method as recited in claim 1, wherein the characteristics includes dimension, material, geometry, and shape of the implant.

9. A computer readable medium carrying one or more sequences of pattern data for designing an implant to support a bone of a person, wherein execution of one or more sequences of pattern data by one or more processors causes the one or more processors to perform the steps of:
(a) determining one or more musculoskeletal loads applied to the bone based on an activity of the person;
(b) selecting a set of properties of the implant;
(c) performing a numerical simulation of the implant and the bone to determine a physical status of the implant under the musculoskeletal loads;
(d) determining if the physical status meets one or more of preset failure conditions;
(e) if the determination in step (d) is negative, taking the implant as an optimized implant; and
(f) if the determination in step (d) is positive, further comprising the steps of
(i) modifying at least one of the properties of the implant; and
(ii) repeating the steps (c) to (f).

10. A computer medium as recited in claim 9, wherein the step (a) includes:
preparing a musculoskeletal model of the person;
preparing a physiological loading condition of the person based on the activity of the person; and
performing a numerical simulation on the musculoskeletal model under the physiological loading condition to determine the one or more musculoskeletal loads.

11. A computer medium as recited in claim 10, wherein the step of preparing the musculoskeletal model includes:
performing a computerized-axial-tomography (CAT) scan on the person's body; and
generating the musculoskeletal model using CAT scan images.

12. A method as recited in claim 10, wherein the step of preparing the musculoskeletal model includes:
preparing a generic musculoskeletal model; and
adjusting a portion of the generic musculoskeletal model based on the patient body geometry.

13. A computer medium as recited in claim 9, wherein the step (c) includes:
applying a finite element model on the implant and the bone.

14. A computer medium as recited in claim 9, wherein the physiological status includes deformation of the bone, a stress distribution in the implant and the bone, and an onset of fatigue failure of the implant.

15. A computer medium as recited in claim 9, wherein the preset failure conditions include a deformation resulting in contact between separate bone segments of the bone, stresses in the implant and the bone are greater than allowable limits, and a number of cycles at an onset of fatigue failure is below an allowable standard.

16. A computer medium as recited in claim 9, wherein the characteristics includes dimension, material, geometry, and shape of the implant.

17. A computer including a processor for running computer-readable program code in memory, the computer comprising:
a first computer program for preparing a physiological loading condition of the person based on an activity of a person;
a second computer program for determining one or more musculoskeletal loads applied to a bone under the physiological loading condition; and
a third computer program for simulating an implant and the bone to determine a physical status of the implant under the musculoskeletal loads.

18. A computer as recited in claim 17, further comprising:
a fourth computer program for determining if the physical status meets one or more of preset failure conditions,
wherein if the physical status meets one or more of the preset failure conditions, the fourth computer program modifies at least one of the characteristics of the implant; and causing the second third computer program to be executed.
